(19) United States
(12) Patent Application Publication
(10) Pub. No.: US 2014/0329027 A1
(43) Pub. Date: Nov. 6, 2014

(54) LOW TEMPERATURE FLOWABLE CURING FOR STRESS ACCOMMODATION

(71) Applicant: Applied Materials, Inc., Santa Clara, CA (US)

(72) Inventors: Jingmei Liang, San Jose, CA (US); Nitin K. Ingle, San Jose, CA (US); Sukwon Hong, Watervliet, NY (US); Abhishek Dube, Belmont, CA (US); DongQing Li, Fremont, CA (US)

(73) Assignee: Applied Materials, Inc., Santa Clara, CA (US)

(21) Appl. No.: 13/955,640

(22) Filed: Jul. 31, 2013

Related U.S. Application Data
(60) Provisional application No. 61/818,707, filed on May 2, 2013.

(51) Int. Cl. B05D 3/10; B05D 3/06; B05D 3/02

(52) U.S. Cl. CPC B05D 3/107; B05D 3/0254; B05D 3/065
USPC 427/551; 427/397.7; 427/558

(57) ABSTRACT

Methods of forming gapfill silicon-containing layers are described. The methods may include providing or forming a silicon-and-hydrogen-containing layer on a patterned substrate. The methods include non-thermally treating the silicon-and-hydrogen-containing layer at low substrate temperature to increase the concentration of Si—Si bonds while the silicon-and-hydrogen-containing layer remains soft. The flaccid layer is able to adjust to the departure of hydrogen from the film and retain a high density without developing a stress. Film qualify is further improved by then inserting O between Si—Si bonds to expand the film in the trenches thereby converting the silicon-and-hydrogen-containing layer to a silicon-and-oxygen-containing layer.

### CROSS-REFERENCES TO RELATED APPLICATIONS

This application claims the benefit of U.S. Prov. Pat. App. No. 61/818,707 filed May 2, 2013, and titled “LOW TEMPERATURE FLOWABLE CURING FOR STRESS ACCOMMODATION” by Liang et al., which is hereby incorporated herein in its entirety by reference for all purposes.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

Semiconductor device geometries have dramatically decreased in size since their introduction several decades ago. Modern semiconductor fabrication equipment routinely produces devices with 32 nm, 28 nm, and 22 nm feature sizes, and new equipment is being developed and implemented to make devices with even smaller geometries. The decreasing feature sizes result in structural features on the device having decreased spatial dimensions. The widths of gaps and trenches on the device narrow to a point where the aspect ratio of gap depth to its width becomes high enough to make it challenging to fill the gap with dielectric material. The depositing dielectric material is prone to clog at the top before the gap completely fills, producing a void or seam in the middle of the gap.

Over the years, many techniques have been developed to avoid having dielectric material clog the top of a gap, or to “heal” the void or seam that has been formed. One approach has been to start with highly flowable precursor materials that may be applied in a liquid phase to a spinning substrate surface (e.g., SOG deposition techniques). These flowable precursors can flow into and fill very small substrate gaps without forming voids or weak seams. However, once these highly flowable materials are deposited, they have to be hardened into a solid dielectric material.

In many instances, the hardening process includes a heat or irradiative treatment to remove chemical groups which imparted flowability to the deposited material to leave behind a solid dielectric such as silicon oxide. Unfortunately, the departing material often leaves behind pores in the hardened dielectric or causes shrinkage of the hardened dielectric, either of which may reduce the quality of the treated material.

Thus, there is a need for new deposition and treatment processes to form solid dielectric gapfill material in trenches on structured substrates without compromising the integrity of the treated materials. This and other needs are addressed in the present application.

### BRIEF SUMMARY OF THE INVENTION

Methods of forming gapfill silicon-containing layers are described. The methods may include providing or forming a silicon-and-hydrogen-containing layer on a patterned substrate. The methods include non-thermally treating the silicon-and-hydrogen-containing layer at low substrate temperature to increase the concentration of Si—Si bonds while the silicon-and-hydrogen-containing layer remains soft. The flaccid layer is able to adjust to the departure of hydrogen from the film and retain a high density without developing a stress. Film qualify is further improved by then inserting O between Si—Si bonds to expand the film in the trenches thereby converting the silicon-and-hydrogen-containing layer to a silicon-and-oxygen-containing layer.

Embodiments of the invention include methods of forming a silicon-and-oxygen-containing layer on a substrate. The methods include the sequential steps of: (1) depositing a silicon-and-hydrogen-containing layer on the substrate at a substrate deposition temperature. The silicon-and-hydrogen-containing layer is flowable during deposition. (2) performing a non-thermal treatment of the silicon-and-hydrogen-containing layer at a non-thermal treatment temperature below 150° C. The non-thermal treatment and non-thermal treatment temperature are sufficient to remove hydrogen from the film but also sufficient to retain the flowability of the silicon-and-hydrogen-containing layer during the non-thermal treatment. The non-thermal treatment modifies the silicon-and-hydrogen-containing layer into a silicon-containing layer. (3) steam annealing the silicon-containing layer at a steam annealing temperature sufficient to convert the silicon-containing layer into the silicon-and-oxygen-containing layer.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a flowchart illustrating selected steps for making a silicon oxide film according to embodiments of the invention.

FIG. 2 shows a substrate processing system according to embodiments of the invention.

FIG. 3A shows a substrate processing chamber according to embodiments of the invention.

FIG. 3B shows a gas distribution showerhead according to embodiments of the invention.

### DETAILED DESCRIPTION OF THE INVENTION

Methods of forming gapfill silicon-containing layers are described. The methods may include providing or forming a silicon-and-hydrogen-containing layer on a patterned substrate. The methods include non-thermally treating the silicon-and-hydrogen-containing layer at low substrate temperature to increase the concentration of Si—Si bonds while the silicon-and-hydrogen-containing layer remains soft. The flaccid layer is able to adjust to the departure of hydrogen from the film and retain a high density without developing a stress. Film qualify is further improved by then inserting O between Si—Si bonds to expand the film in the trenches thereby converting the silicon-and-hydrogen-containing layer to a silicon-and-oxygen-containing layer.

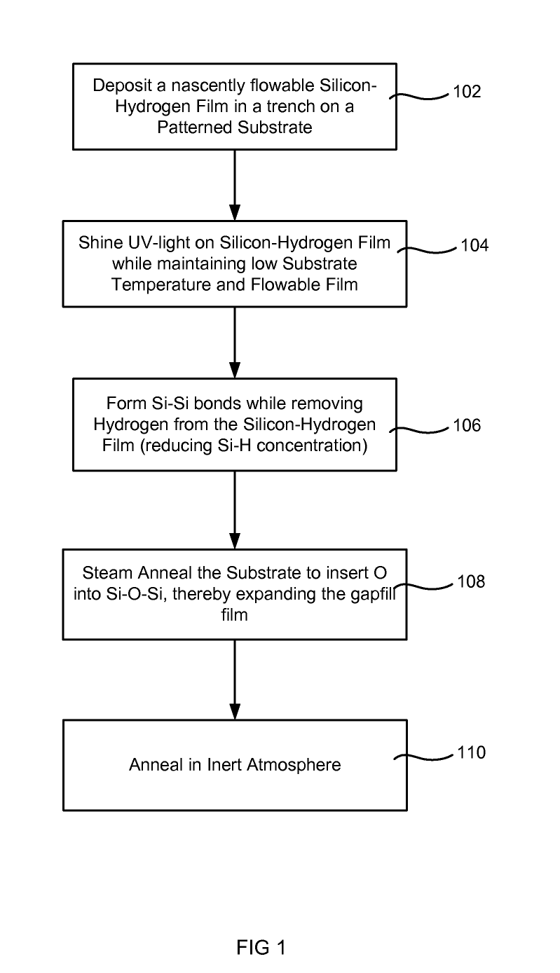

In order to better understand and appreciate the invention, reference is now made to FIG. 1 which is a flowchart showing selected steps in methods of making silicon oxide films according to embodiments of the invention. Though these processes are useful for a variety of surface topologies, the exemplary method includes providing a substrate comprising a narrow gap into a substrate processing region. The substrate may have a plurality of gaps for the spacing and structure of device components (e.g., transistors) formed on the substrate. The gaps may have a height and width that define an aspect ratio (AR) of the height to the width (i.e., H/W) that is significantly greater than 1:1 (e.g., 5:1 or more, 6:1 or more, 7:1 or more, 8:1 or more, 9:1 or more, 10:1 or more, 11:1 or more, 12:1 or more, etc.). In many instances the high AR is due to small gap widths that below 32 nm, below 28 nm, below 22 nm or below 16 nm, in disclosed embodiments.

The exemplary method includes forming a silicon-and-hydrogen-containing layer on the substrate and in the narrow gap. Spin-on dielectric (SOD) films fall under this category as well as some chemical vapor deposition techniques. Silicon-and-hydrogen-containing layers may be deposited to flow in and fill the narrow gap and may then be converted to silicon oxide in the subsequent steps described herein.

Following the deposition of the silicon-and-hydrogen-containing layer, the deposition substrate is non-thermally treated in an ozone-containing atmosphere 104. The non-thermal treatment reduces the concentration of hydrogen while increasing the concentration of Si—Si bonds in the film 106, including in the trench. The deposition substrate may remain in the same substrate processing region for non-thermal treatment as was used for deposition, or the substrate may be transferred to a different chamber for the non-thermal treatment. The substrate deposition temperature may be below 200° C. in embodiments of the invention. In general, the set of operations (e.g. 102-106) may be repeated an integral number of times to further improve the conversion efficiency to obtain a higher concentration of Si—Si bonds.

The non-thermal treatments may involve e-beam exposure or UV exposure. The wavelengths of suitable UV light may be between 100 nm and 450 nm, or may be between 100 nm and 400 nm in disclosed embodiments. The inventors have found that maintaining a non-thermal treatment temperature lower than prior art levels enables the film to remain flowable, soft or malleable during the non-thermal treatment. The benefits of this lie in the concurrent rearrangement of the silicon-and-hydrogen-containing film as hydrogen is removed from the film. The concurrent rearrangement increases the density of the settling film within trenches on the substrate. Prior art techniques involving e-beam exposure, UV exposure or other non-thermal treatments have inevitably increased the substrate temperature resulting in solidification of the film prior to formation of Si—Si bonds within the trenches. Premature solidification, as witnessed in the prior art processes, does not allow additional material to make its way into the trench as the hydrogen is released and exhausted from the substrate processing region. As a result, premature solidification results in voids during subsequent processing. The silicon-and-hydrogen-containing layer comprises Si—H bonds immediately following the depositing step, and the non-thermal treating step removes Si—H bonds and forms Si—Si bonds.

The inventors have witnessed this novel phenomenon by including additional cooling capabilities to processing chambers in order to cool the substrate and counteract the natural heating effects of the non-thermal treatments described herein. The non-thermal treatment temperature less than or about 150° C., less than or about 100° C., less than or about 75° C., less than or about 50° C. For example, the effectiveness of the non-thermal treatment has been found to be more pronounced at 10° C. than 50° C. In embodiments of the invention, the non-thermal treatment temperature may be less than the substrate deposition temperature of the patterned substrate during deposition of the silicon-and-hydrogen-containing layer.

Irradiating the silicon-and-hydrogen-containing film must be controlled such that the quantity of irradiation is sufficient to cause the Si—Si bonds to form but not to the point where the film becomes solid prematurely. The inventors have found that the duration may be shortened for large dosing magnitudes of the non-thermal treatment in order to remain in the successful processing window. This allows for a wide variety of radiative treatment sources and properties simply by adjusting the non-thermal treatment duration. Non-thermal treatment durations may be between about 1 second and about 5 minutes in disclosed embodiments. An effective dose may be determined by measuring refractive index following the non-thermal treatment—the refractive index should rise after the treatment as a result of the continued flowability during the crosslinking of Si—Si bonds in the processed film. Alternatively, the film stress may be measured to ensure that it remains below about 100 MPa or 50 MPa in disclosed embodiments. The film stress after non-thermal treatment may be either compressive or tensile. The film can also be measured to ensure that the film thickness transverse to the substrate surface decreases by 15% or more, 20% or more, or 25% or more in embodiments. The film thickness is a measure of how much material was needed to concurrently refill the gap during the non-thermal treatment.

Following non-thermal treatment of the silicon-and-hydrogen-containing layer and formation of the Si—Si bonds, the deposition substrate may be steam annealed in a water-containing atmosphere 108 to form a silicon-and-oxygen-containing layer. The water-containing atmosphere contains water vapor (H₂O) which may be referred to herein as steam. The silicon-and-hydrogen-containing layer comprises Si—Si bonds immediately following the non-thermal treating step, and the steam annealing step removes Si—Si bonds and forms Si—O—Si bonds. The steam inserts oxygen atoms within Si—Si bonds and expands the film to counteract the prior art tendency of flowable films to shrink. Again, the deposition substrate may remain in the same substrate processing region used for the non-thermal treatment when the water-containing atmosphere is introduced, or the substrate may be transferred to a different chamber for steam anneal 108. In general, the set of operations (exemplary 102-108) may be repeated an integral number of times to further improve the conversion efficiency to obtain a higher concentration of Si—Si bonds.

The steam anneal temperature of the substrate may be between 150° C. and 550° C., or between 200° C. and 500° C., or between 250° C. and 400° C. disclosed embodiments. The duration of the steam anneal may be greater than about 5 seconds or greater than about 10 seconds in embodiments. The duration of the steam anneal may be less than about 60 seconds or less than or about 45 seconds in embodiments. Upper bounds may be combined with lower bounds to form additional ranges for the duration of the steam anneal according to additional disclosed embodiments.

No plasma is present in the substrate processing region, in embodiments, to avoid generating hyper-reactive oxygen which may modify the near surface network and thwart subsurface penetration of the insertion of O into Si—Si to form Si—O—Si bonds. The flow rate of the steam into the substrate processing region during the steam anneal step may be greater than or about 1 slm, greater than or about 2 slm, greater than or about 5 slm or greater than or about 10 slm, in disclosed embodiments. The partial pressure of the steam during the steam anneal step may be greater than or about 10 Torr, greater than or about 20 Torr, greater than or about 40 Torr or greater than or about 50 Torr, in disclosed embodiments.

Following steam anneal, the converted silicon-and-oxygen-containing layer may be dry annealed in an dry environment at high temperature to complete the formation of a silicon oxide film 110. The dry atmosphere may be essentially a vacuum, or it may include a noble gas or another inert gas, i.e. any chemical which does not significantly become incorporated in the converting film. The dry anneal temperature of the substrate may be less than or about 1100° C., less than or about 1000° C., less than or about 900° C. or less than or about 800° C. in disclosed embodiments. The temperature of the substrate may be greater than or about 500° C., greater than or about 600° C., greater than or about 700° C. or greater than or about 800° C. in disclosed embodiments. The dry anneal may be in-situ or in another processing region/system and may occur as a batch or single wafer process. Prior art techniques resulted in tensile stress in the gapfill silicon-and-oxygen-containing films which was exacerbated by the dry anneal. Silicon-and-oxygen-containing films described herein were expanded during the steam anneal due to the insertion of the oxygen atom between silicon-silicon bonds, which serves to produce a compressive stress, in disclosed embodiments. The compressive stress of the gapfill silicon-and-oxygen-containing layer is mitigated by the dry anneal which produces a much lower stress silicon oxide gapfill layer at the conclusion of the process. Following the steam anneal, the film may be examined using an SEM after breaking open a cross-sectional view. Any defects may be decorated by exposure to a hydro-fluoric acid treatment and a subsequent SEM should indicate a more smooth, more featureless gapfill material compared to prior art gapfill dielectrics decorated in the same manner at the analogous stage in an otherwise-similar process.

The steam of the steam anneal provides oxygen to convert the silicon-and-hydrogen-containing film into the silicon-and-oxygen-containing film and subsequently into the silicon oxide film. Carbon may or may not be present in the silicon-and-hydrogen-containing film in embodiments of the invention. If absent, the lack of carbon in the silicon-and-hydrogen-containing film results in fewer pores formed in the final silicon oxide film. It also results in less volume reduction (i.e., shrinkage) of the film during the conversion to the silicon oxide. For example, where a silicon-carbon layer formed from carbon-containing silicon precursors may shrink by 40 vol. % or more when converted to silicon oxide, a substantially carbon-free silicon-and-hydrogen-containing films may shrink by about 15 vol. % or less. Even this shrinkage may be far less or nonexistent as a result of the insertion of oxygen atoms between adjacent silicon atoms during the steam anneal. As a result of the flowability of the silicon-and-hydrogen-containing film and the lack of shrinkage, the silicon-and-oxygen-containing film produced according to methods described herein may fill the narrow trench so it is free of voids.

The films herein may be described with the adjective “flowable”. A flowable film, as used herein, describes a film which exists on the surface of the substrate and flows during the operation (deposition,thermal treatment, non-thermal treatment) associated with the use of this adjective. The flowable silicon-and-hydrogen-containing films described above may include silicon-nitrogen-and-hydrogen-containing films, as an example. The silicon-and-hydrogen-containing layer may also be a carbon-free silicon-and-hydrogen-containing layer in disclosed embodiments. Similarly, the silicon-and-hydrogen-containing layer may be a nitrogen-free silicon-and-hydrogen-containing layer.

An exemplary operation of depositing a silicon-nitrogen-and-hydrogen-containing layer may involve a chemical vapor deposition process which begins by providing a carbon-free silicon precursor to a substrate processing region. The carbon-free silicon-containing precursor may be, for example, a silicon-and-nitrogen-containing precursor, a silicon-and-hydrogen precursor, or a silicon-nitrogen-and-hydrogen-containing precursor, among other classes of silicon precursors. The silicon-precursor may be oxygen-free in addition to carbon-free. The lack of oxygen results in a lower concentration of silanol (Si—OH) groups in the silicon-and-nitrogen-containing layer formed from the precursors. Excess silanol moieties in the deposited film can also cause increased porosity and shrinkage during post deposition steps that remove the hydroxyl (—OH) moieties from the deposited layer.

Specific examples of carbon-free silicon precursors may include silyl-amines such as H₂N(SiH₃), HN(SiH₃)₂, and N(SiH₃)₃, among other silyl-amines. The flow rates of a silyl-amine may be greater than or about 200 sccm, greater than or about 300 sccm or greater than or about 500 sccm in disclosed embodiments. All flow rates given herein refer to a dual chamber substrate processing system. Single wafer systems would require half these flow rates and other wafer sizes would require flow rates scaled by the processed area. These silyl-amines may be mixed with additional gases that may act as carrier gases, reactive gases, or both. Examplary additional gases include H₂, N₂, NH₃, He, and Ar, among other gases. Examples of carbon-free silicon precursors may also include silane (SiH₄) either alone or mixed with other silicon (e.g., N(SiH₃)₃), hydrogen (e.g., H₂), and/or nitrogen (e.g., N₂, NH₃) containing gases. Carbon-free silicon precursors may also include disilane, trisilane, even higher-order silanes, and chlorinated silanes, alone or in combination with one another or the previously mentioned carbon-free silicon precursors.

A radical-nitrogen precursor may also be provided to the substrate processing region. The radical-nitrogen precursor is a nitrogen-radical-containing precursor that was generated outside the substrate processing region from a more stable nitrogen precursor. For example, a stable nitrogen precursor compound containing ammonia (NH₃), hydrazine (N₂H₄) and/or N₂ may be activated in a chamber plasma region or a remote plasma system (RPS) outside the processing chamber to form the radical-nitrogen precursor, which is then transported into the substrate processing region. The stable nitrogen precursor may also be a mixture comprising NH₃ & N₂, NH₃ & H₂, NH₃ & N₂ & H₂ and N₂ & H₂, in disclosed embodiments. Hydrazine may also be used in place of or in combination with NH₃ in the mixtures with N₂ and H₂. The flow rate of the stable nitrogen precursor may be greater than or about 300 sccm, greater than or about 500 sccm or greater than or about 700 sccm in disclosed embodiments. The radical-nitrogen precursor produced in the chamber plasma region may be one or more of .N, .NH, .NH₂, etc., and may also be accompanied by ionized species formed in the plasma. Sources of oxygen may also be combined with the more stable nitrogen precursor in the remote plasma which will act to pre-load the film with oxygen while decreasing flowability. Sources of oxygen may include one or more of O₂, H₂O, O₃, H₂O₂, N₂O, NO or NO₂. Generally speaking, a radical precursor may be used which does not contain nitrogen and the nitrogen for the silicon-nitrogen-and-hydrogen-containing layer is then provided by nitrogen from the carbon-free silicon-containing precursor.

In embodiments employing a chamber plasma region, the radical-nitrogen precursor is generated in a section of the substrate processing region partitioned from a deposition region where the precursors mix and react to deposit the silicon-and-nitrogen-containing layer on a deposition substrate (e.g., a semiconductor wafer). The radical-nitrogen precursor may also be accompanied by a carrier gas such as hydrogen (H₂), nitrogen (N₂), helium, etc. The substrate processing region may be described herein as “plasma-free” during the growth of the silicon-nitrogen-and-hydrogen-containing layer and during the low temperature ozone cure. “Plasma-free” does not necessarily mean the region is devoid of plasma. The borders of the plasma in the chamber plasma region are hard to define and may encroach upon the substrate processing region through the apertures in the showerhead. In the case of an inductively-coupled plasma, e.g., a small amount of ionization may be initiated within the substrate processing region directly. Furthermore, a low intensity plasma may be created in the substrate processing region without eliminating the flowable nature of the forming film. All causes for a plasma having much lower ion density than the chamber plasma region during the creation of the radical nitrogen precursor do not deviate from the scope of “plasma-free” as used herein. The substrate processing region may also be plasma-free, using the same definition, during the steam anneals described herein.

In the substrate processing region, the carbon-free silicon precursor and the radical-nitrogen precursor mix and react to deposit a silicon-nitrogen-and-hydrogen-containing film on the deposition substrate. The deposited silicon-nitrogen-and-hydrogen-containing film may deposit conformally with some recipe combinations in embodiments. In other embodiments, the deposited silicon-nitrogen-and-hydrogen-containing film has flowable characteristics unlike conventional silicon nitride (Si₃N₄) film deposition techniques. The flowable nature of the formation allows the film to flow into narrow gaps trenches and other structures on the deposition surface of the substrate.

The flowability may be due to a variety of properties which result from mixing a radical-nitrogen precursors with carbon-free silicon precursor. These properties may include a significant hydrogen component in the deposited film and/or the presence of short chained polysilazane polymers. These short chains grow and network to form more dense dielectric material during and after the formation of the film. For example the deposited film may have a silazane-type, Si—NH—Si backbone (i.e., a carbon-free Si—N—H film). When both the silicon precursor and the radical-nitrogen precursor are carbon-free, the deposited silicon-nitrogen-and-hydrogen-containing film is also substantially carbon-free. Of course, “carbon-free” does not necessarily mean the film lacks even trace amounts of carbon. Carbon contaminants may be present in the precursor materials that find their way into the deposited silicon-and-nitrogen-containing precursor. The amount of these carbon impurities however are much less than would be found in a silicon precursor having a carbon moiety (e.g., TEOS, TMDSO, etc.).

As described above, the deposited silicon-nitrogen-and-hydrogen-containing layer may be produced by combining a radical-nitrogen precursor with a variety of carbon-free silicon-containing precursors. The carbon-free silicon-containing precursor may be essentially nitrogen-free, in embodiments. In some embodiments, both the carbon-free silicon-containing precursor and the radical-nitrogen precursor contain nitrogen. On the other hand, the radical precursor may be essentially nitrogen-free, in embodiments, and the nitrogen for the silicon-nitrogen-and-hydrogen-containing layer may be supplied by the carbon-free silicon-containing precursor. So most generally speaking, the radical precursor will be referred to herein as a “radical-nitrogen-and/or-hydrogen precursor,” which means that the precursor contains nitrogen and/or hydrogen. Analogously, the precursor flowed into the plasma region to form the radical-nitrogen-and/or-hydrogen precursor will be referred to as a nitrogen-and/or-hydrogen-containing precursor. These generalizations may be applied to each of the embodiments disclosed herein. In embodiments, the nitrogen-and/or-hydrogen-containing precursor comprises hydrogen (H₂) while the radical-nitrogen-and/or-hydrogen precursor comprises .H, etc.

### Exemplary Silicon Oxide Deposition System

Deposition chambers that may implement embodiments of the present invention may include high-density plasma chemical vapor deposition (HDP-CVD) chambers, plasma enhanced chemical vapor deposition (PECVD) chambers, sub-atmospheric chemical vapor deposition (SACVD) chambers, and thermal chemical vapor deposition chambers, among other types of chambers. Specific examples of CVD systems that may implement embodiments of the invention include the CENTURA ULTIMA® HDP-CVD chambers/systems, and PRODUCER® PECVD chambers/systems, available from Applied Materials, Inc. of Santa Clara, Calif.

Examples of substrate processing chambers that can be used with exemplary methods of the invention may include those shown and described in co-assigned U.S. Provisional Patent App. No. 60/803,499 to Lubomirsky et al, filed May 30, 2006, and titled “PROCESS CHAMBER FOR DIELECTRIC GAPFILL,” the entire contents of which is herein incorporated by reference for all purposes. Additional exemplary systems may include those shown and described in U.S. Pat. Nos. 6,387,207 and 6,830,624, which are also incorporated herein by reference for all purposes.

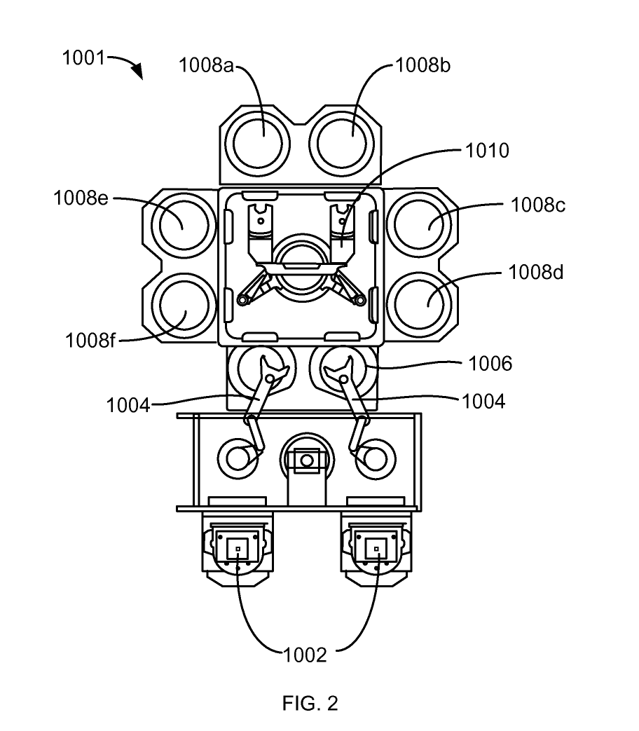

Embodiments of the deposition systems may be incorporated into larger fabrication systems for producing integrated circuit chips. FIG. 2 shows one such system 1001 of deposition, baking and curing chambers according to disclosed embodiments. In the figure, a pair of FOUPs (front opening unified pods) 1002 supply substrates (e.g., 300 mm diameter wafers) that are received by robotic arms 1004 and placed into a low pressure holding area 1006 before being placed into one of the wafer processing chambers 1008a-f. A second robotic arm 1010 may be used to transport the substrate wafers from the holding area 1006 to the processing chambers 1008a-f and back.

The processing chambers 1008a-f may include one or more system components for depositing, annealing, curing and/or etching a flowable dielectric film on the substrate wafer. In one configuration, two pairs of the processing chamber (e.g., 1008c-d and 1008e-f) may be used to deposit the flowable dielectric material on the substrate, and the third pair of processing chambers (e.g., 1008a-b) may be used to anneal the deposited dielectric. In another configuration, the same two pairs of processing chambers (e.g., 1008c-d and 1008e-f) may be configured to both deposit and anneal a flowable dielectric film on the substrate, while the third pair of chambers (e.g., 1008a-b) may be used for UV or E-beam curing of the deposited film. In still another configuration, all three pairs of chambers (e.g., 1008a-f) may be configured to deposit and cure a flowable dielectric film on the substrate. In yet another configuration, two pairs of processing chambers (e.g., 1008c-d and 1008e-f) may be used for both deposition and UV or E-beam curing of the flowable dielectric, while a third pair of processing chambers (e.g. 1008a-b) may be used for annealing the dielectric film. Any one or more of the processes described may be carried out on chamber(s) separated from the fabrication system shown in disclosed embodiments.

In addition, one or more of the process chambers 1008a-f may be configured as a wet treatment chamber. These process chambers include heating the flowable dielectric film in an atmosphere that includes moisture. Thus, embodiments of system 1001 may include wet treatment chambers 1008a-b and anneal processing chambers 1008c-d to perform both wet and dry anneals on the deposited dielectric film.

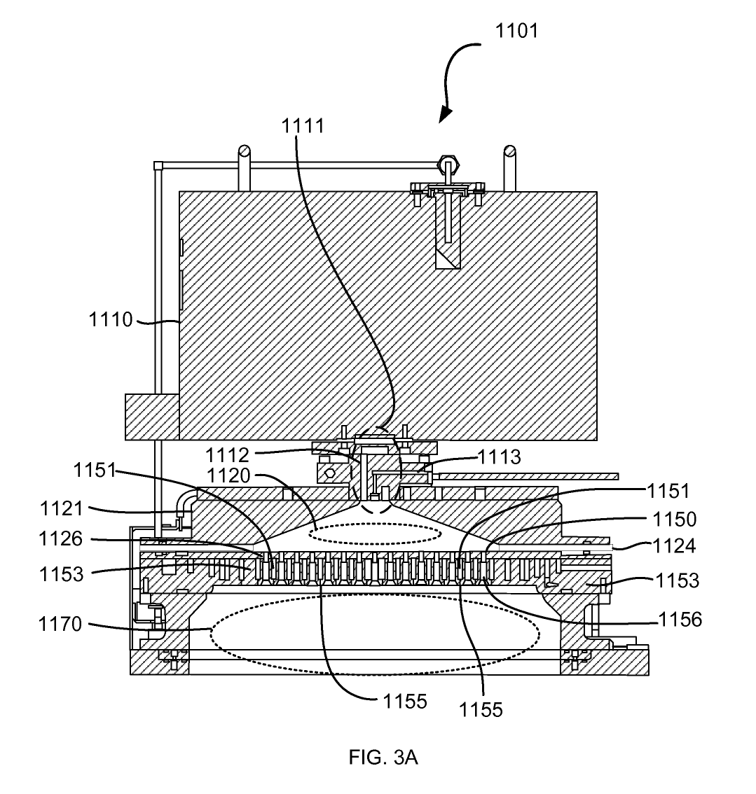

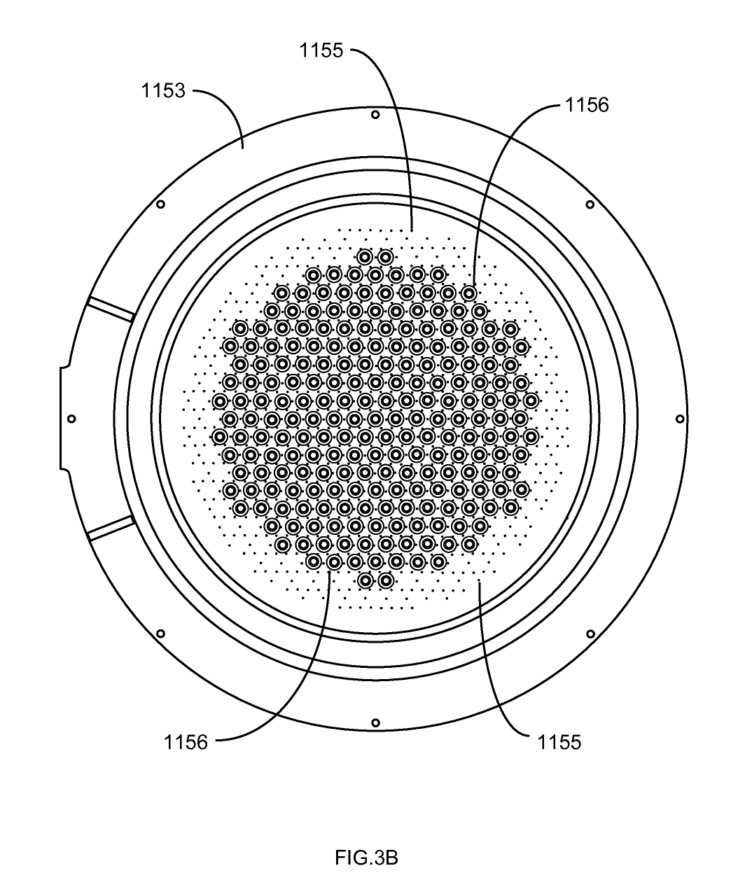

FIG. 3A is a substrate processing chamber 1101 according to disclosed embodiments. A remote plasma system (RPS) 1110 may process a gas which then travels through a gas inlet assembly 1111. Two distinct gas supply channels are visible within the gas inlet assembly 1111. A first channel 1112 carries a gas that passes through the remote plasma system RPS 1110, while a second channel 1113 bypasses the RPS 1110. The first channel 502 may be used for the process gas and the second channel 1113 may be used for a treatment gas in disclosed embodiments. The lid (or conductive top portion) 1121 and a perforated partition (also referred to as a showerhead) 1153 are shown with an insulating ring 1124 in between, which allows an AC potential to be applied to the lid 1121 relative to perforated partition 1153. The process gas travels through first channel 1112 into chamber plasma region 1120 and may be excited by a plasma in chamber plasma region 1120 alone or in combination with RPS 1110. The combination of chamber plasma region 1120 and/or RPS 1110 may be referred to as a remote plasma system herein. The perforated partition (showerhead) 1153 separates chamber plasma region 1120 from a substrate processing region 1170 beneath showerhead 1153. Showerhead 1153 allows a plasma present in chamber plasma region 1120 to avoid directly exciting gases in substrate processing region 1170, while still allowing excited species to travel from chamber plasma region 1120 into substrate processing region 1170.

Showerhead 1153 is positioned between chamber plasma region 1120 and substrate processing region 1170 and allows plasma effluents (excited derivatives of precursors or other gases) created within chamber plasma region 1120 to pass through a plurality of through-holes 1156 that traverse the thickness of the plate. The showerhead 1153 also has one or more hollow volumes 1151 which can be filled with a precursor in the form of a vapor or gas (such as a silicon-containing precursor) and pass through small holes 1155 into substrate processing region 1170 but not directly into chamber plasma region 1120. Showerhead 1153 is thicker than the length of the smallest diameter 1150 of the through-holes 1156 in this disclosed embodiment. In order to maintain a significant concentration of excited species penetrating from chamber plasma region 1120 to substrate processing region 1170, the length 1126 of the smallest diameter 1150 of the through-holes may be restricted by forming larger diameter portions of through-holes 1156 part way through the showerhead 1153. The length of the smallest diameter 1150 of the through-holes 1156 may be the same order of magnitude as the smallest diameter of the through-holes 1156 or less in disclosed embodiments.

In the embodiment shown, showerhead 1153 may distribute (via through-holes 1156) process gases which contain oxygen, hydrogen and/or nitrogen and/or plasma effluents of such process gases upon excitation by a plasma in chamber plasma region 1120. In embodiments, the process gas introduced into the RPS 1110 and/or chamber plasma region 1120 through first channel 1112 may contain one or more of oxygen (O₂), ozone (O₃), N₂O, NO, NO₂, NH₃, NₓH_{y} including N₂H₄, silane, disilane, TSA and DSA. The process gas may also include a carrier gas such as helium, argon, nitrogen (N₂), etc. The second channel 1113 may also deliver a process gas and/or a carrier gas, and/or a film-curing gas used to remove an unwanted component from the growing or as-deposited film. Plasma effluents may include ionized or neutral derivatives of the process gas and may also be referred to herein as a radical-oxygen precursor and/or a radical-nitrogen precursor referring to the atomic constituents of the process gas introduced.

In embodiments, the number of through-holes 1156 may be between about 60 and about 2000. Through-holes 1156 may have a variety of shapes but are most easily made round. The smallest diameter 1150 of through-holes 1156 may be between about 0.5 mm and about 20 mm or between about 1 mm and about 6 mm in disclosed embodiments. There is also latitude in choosing the cross-sectional shape of through-holes, which may be made conical, cylindrical or a combination of the two shapes. The number of small holes 1155 used to introduce a gas into substrate processing region 1170 may be between about 100 and about 5000 or between about 500 and about 2000 in disclosed embodiments. The diameter of the small holes 1155 may be between about 0.1 mm and about 2 mm.

FIG. 3B is a bottom view of a showerhead 1153 for use with a processing chamber according to disclosed embodiments. Showerhead 1153 corresponds with the showerhead shown in FIG. 3A. Through-holes 1156 are depicted with a larger inner-diameter (ID) on the bottom of showerhead 1153 and a smaller ID at the top. Small holes 1155 are distributed substantially evenly over the surface of the showerhead, even amongst the through-holes 1156 which helps to provide more even mixing than other embodiments described herein.

An exemplary film is created on a substrate supported by a pedestal (not shown) within substrate processing region 1170 when plasma effluents arriving through through-holes 1156 in showerhead 1153 combine with a silicon-containing precursor arriving through the small holes 1155 originating from hollow volumes 1151. Though substrate processing region 1170 may be equipped to support a plasma for other processes such as curing, no plasma is present during the growth of the exemplary film.

A plasma may be ignited either in chamber plasma region 1120 above showerhead 1153 or substrate processing region 1170 below showerhead 1153. A plasma is present in chamber plasma region 1120 to produce the radical nitrogen precursor from an inflow of a nitrogen-and-hydrogen-containing gas. An AC voltage typically in the radio frequency (RF) range is applied between the conductive top lid 1121 of the processing chamber and showerhead 1153 to ignite a plasma in chamber plasma region 1120 during deposition. An RF power supply generates a high RF frequency of 13.56 MHz but may also generate other frequencies alone or in combination with the 13.56 MHz frequency.

The top plasma may be left at low or no power when the bottom plasma in the substrate processing region 1170 is turned on to either cure a film or clean the interior surfaces bordering substrate processing region 1170. A plasma in substrate processing region 1170 is ignited by applying an AC voltage between showerhead 1153 and the pedestal or bottom of the chamber. A cleaning gas may be introduced into substrate processing region 1170 while the plasma is present. No plasma is used during steam anneal, in embodiments of the invention.

The pedestal may have a heat exchange channel through which a heat exchange fluid flows to control the temperature of the substrate. This configuration allows the substrate temperature to be cooled or heated to maintain relatively low temperatures (from −50° C. through about 120° C.). The heat exchange fluid may comprise ethylene glycol and water. The wafer support platter of the pedestal (preferably aluminum, ceramic, or a combination thereof) may also be resistively heated in order to achieve relatively high temperatures (from about 120° C. through about 1100° C.) using an embedded single-loop embedded heater element configured to make two full turns in the form of parallel concentric circles. An outer portion of the heater element may run adjacent to a perimeter of the support platter, while an inner portion runs on the path of a concentric circle having a smaller radius. The wiring to the heater element passes through the stem of the pedestal.

The substrate processing system is controlled by a system controller. In an exemplary embodiment, the system controller includes a hard disk drive, a floppy disk drive and a processor. The processor contains a single-board computer (SBC), analog and digital input/output boards, interface boards and stepper motor controller boards. Various parts of CVD system conform to the Versa Modular European (VME) standard which defines board, card cage, and connector dimensions and types. The VME standard also defines the bus structure as having a 16-bit data bus and a 24-bit address bus.

The system controller controls all of the activities of the CVD machine. The system controller executes system control software, which is a computer program stored in a computer-readable medium. Preferably, the medium is a hard disk drive, but the medium may also be other kinds of memory. The computer program includes sets of instructions that dictate the timing, mixture of gases, chamber pressure, chamber temperature, RF power levels, susceptor position, and other parameters of a particular process. Other computer programs stored on other memory devices including, for example, a floppy disk or other another appropriate drive, may also be used to instruct the system controller.

A process for depositing a film stack on a substrate or a process for cleaning a chamber can be implemented using a computer program product that is executed by the system controller. The computer program code can be written in any conventional computer readable programming language: for example, 68000 assembly language, C, C++, Pascal, Fortran or others. Suitable program code is entered into a single file, or multiple files, using a conventional text editor, and stored or embodied in a computer usable medium, such as a memory system of the computer. If the entered code text is in a high level language, the code is compiled, and the resultant compiler code is then linked with an object code of precompiled Microsoft Windows® library routines. To execute the linked, compiled object code the system user invokes the object code, causing the computer system to load the code in memory. The CPU then reads and executes the code to perform the tasks identified in the program.

The interface between a user and the controller is via a flat-panel touch-sensitive monitor. In the preferred embodiment two monitors are used, one mounted in the clean room wall for the operators and the other behind the wall for the service technicians. The two monitors may simultaneously display the same information, in which case only one accepts input at a time. To select a particular screen or function, the operator touches a designated area of the touch-sensitive monitor. The touched area changes its highlighted color, or a new menu or screen is displayed, confirming communication between the operator and the touch-sensitive monitor. Other devices, such as a keyboard, mouse, or other pointing or communication device, may be used instead of or in addition to the touch-sensitive monitor to allow the user to communicate with the system controller.

As used herein “substrate” may be a support substrate with or without layers formed thereon. The support substrate may be an insulator or a semiconductor of a variety of doping concentrations and profiles and may, for example, be a semiconductor substrate of the type used in the manufacture of integrated circuits. A layer of “silicon oxide” may include minority concentrations of other elemental constituents such as nitrogen, hydrogen, carbon and the like. In some embodiments of the invention, silicon oxide consists essentially of silicon and oxygen. A gas in an “excited state” describes a gas wherein at least some of the gas molecules are in vibrationally-excited, dissociated and/or ionized states. A gas (or precursor) may be a combination of two or more gases (precursors). The term “trench” is used throughout with no implication that the etched geometry has a large horizontal aspect ratio. Viewed from above the surface, trenches may appear circular, oval, polygonal, rectangular, or a variety of other shapes. The term “via” is used to refer to a low aspect ratio trench which may or may not be filled with metal to form a vertical electrical connection. The term “precursor” is used to refer to any process gas (or vaporized liquid droplet) which takes part in a reaction to either remove or deposit material from a surface.

The terms “irradiate”, “irradiating” and “irradiation” will be used herein to include e-beam treatments, optical treatments such as UV-treatments, as well as other particle impingement treatments. The term “trench” is used throughout with no implication that the etched geometry has a large horizontal aspect ratio. Viewed from above the surface, trenches may appear circular, oval, polygonal, rectangular, or a variety of other shapes. The term “via” is used to refer to a low aspect ratio trench which may or may not be filled with metal to form a vertical electrical connection. As used herein, a conformal layer refers to a generally uniform layer of material on a surface in the same shape as the surface, i.e., the surface of the layer and the surface being covered are generally parallel. A person having ordinary skill in the art will recognize that the deposited material likely cannot be 100% conformal and thus the term “generally” allows for acceptable tolerances.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the precursor” includes reference to one or more precursor and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of forming a silicon-and-oxygen-containing layer on a substrate, the method comprising the sequential steps of:
depositing a silicon-and-hydrogen-containing layer on the substrate at a substrate deposition temperature, wherein the silicon-and-hydrogen-containing layer is flowable during deposition;
performing a non-thermal treatment of the silicon-and-hydrogen-containing layer at a non-thermal treatment temperature below 150° C., wherein the non-thermal treatment and non-thermal treatment temperature are sufficient to remove hydrogen from the film but also sufficient to retain the flowability of the silicon-and-hydrogen-containing layer during the non-thermal treatment, wherein the non-thermal treatment modifies the silicon-and-hydrogen-containing layer into a silicon-containing layer; and
steam annealing the silicon-containing layer at a steam annealing temperature sufficient to convert the silicon-containing layer into the silicon-and-oxygen-containing layer.

2. The method of claim 1 wherein the non-thermal treatment temperature is less than 75° C.

3. The method of claim 1 wherein the steam annealing temperature is between 150° C. and 550° C.

4. The method of claim 1 wherein the substrate deposition temperature is less than or about 200° C.

5. The method of claim 1 wherein the non-thermal treatment temperature is less than or about the substrate deposition temperature.

6. The method of claim 1 wherein the silicon-and-hydrogen-containing layer comprises Si—H bonds immediately following the depositing step, and the non-thermal treating step removes Si—H bonds and forms Si—Si bonds.

7. The method of claim 1 wherein the silicon-and-hydrogen-containing layer comprises Si—Si bonds immediately following the non-thermal treating step, and the steam annealing step removes Si—Si bonds and forms Si—O—Si bonds.

8. The method of claim 1 further comprising raising a temperature of the substrate to a dry anneal temperature above or about 500° C. after the steam annealing step.

9. The method of claim 1 wherein the substrate is patterned and has a trench having a width of about 32 nm or less.

10. The method of claim 1 wherein the silicon-and-hydrogen-containing layer is a silicon-nitrogen-and-hydrogen-containing layer.

11. The method of claim 1 wherein the silicon-and-hydrogen-containing layer is a carbon-free silicon-and-hydrogen-containing layer.

12. The method of claim 1 wherein the silicon-and-hydrogen-containing layer is a nitrogen-free silicon-and-hydrogen-containing layer.

13. The method of claim 1 wherein the operation of performing the non-thermal treatment comprises shining UV light on the substrate.

14. The method of claim 1 wherein the operation of performing the non-thermal treatment comprises irradiating the substrate with an electron beam.

15. The method of claim 1 wherein the steps of depositing the silicon-and-hydrogen-containing layer, performing the non-thermal treatment and steam annealing the silicon-containing layer are carried out in the same substrate processing region.

16. The method of claim 1 wherein the sequential steps of depositing the silicon-and-hydrogen-containing layer, performing the non-thermal treatment and steam annealing the silicon-containing layer are repeated again in order to process a thicker layer of material.

17. The method of claim 1 wherein the silicon-and-hydrogen-containing layer is a silicon-nitrogen-and-hydrogen-containing layer formed by:
flowing a nitrogen-containing precursor into a plasma region to produce a radical-nitrogen precursor;
combining a silicon-and-nitrogen-containing precursor with the radical-nitrogen precursor in a plasma-free substrate processing region; and
depositing the silicon-nitrogen-and-hydrogen-containing layer on the substrate.

18. The method of claim 17 wherein the nitrogen-containing precursor comprises ammonia.

19. The method of claim 17 wherein the silicon-and-nitrogen-containing precursor comprises N(SiH₃)₃.
